(19) United States
(12) Patent Application Publication
(10) Pub. No.: US 2009/0002229 A1
(43) Pub. Date: Jan. 1, 2009

(54) ANTENNA ELEMENT AND ANTENNA UNIT CAPABLE OF RECEIVING TWO KINDS OF RADIO WAVES

(75) Inventors: Junichi Noro, Akita (JP); Takeshi Iizuka, Akita (JP); Toshiaki Aizawa, Akita (JP); Kyuichi Sato, Akita (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tama-shi (JP)

(21) Appl. No.: 12/144,308

(22) Filed: Jun. 23, 2008

(30) Foreign Application Priority Data
Jun. 26, 2007 (JP) 2007-167414
Mar. 25, 2008 (JP) 2008-077141

(51) Int. Cl. G01S 1/00; H01Q 1/48

(52) U.S. Cl. 342/357.12; 343/846

(57) ABSTRACT

An antenna element includes a dielectric board, a first antenna radiation electrode formed on a top surface of the dielectric board at an outer region, a second antenna radiation electrode formed on the top surface of the dielectric board at a central portion, a ground electrode formed on a bottom surface of the dielectric board, a feeding pattern formed on the side surface of the dielectric board for feeding to the first antenna radiation electrode by electromagnetic coupling, and a feeding pin having an end connected to the second antenna radiation electrode. A combination of the first antenna radiation electrode, the ground electrode, and the feeding pattern serves as a first antenna portion for receiving a first radio wave. A combination of the second antenna radiation electrode, the ground electrode, and the feeding pin serves as a second antenna portion for receiving a second radio wave.

This application is based upon and claims the benefit of priority from Japanese patent application No. 2007-167414, filed on Jun. 26, 2007, and Japanese patent application No. 2008-77141, filed on Mar. 25, 2008, the disclosures of which are incorporated herein their entirety by reference.

### BACKGROUND OF THE INVENTION

This invention relates to an antenna element and an antenna unit and, in particular, to a hybrid antenna element and a hybrid antenna unit for receiving two kinds of electric waves.

In the manner which is known in the art, recently, various different antennas are mounted in a vehicle such as an automobile. For example, there are, as such antennas, a GPS (Global Positioning System) antenna, an SDARS (Satellite Digital Audio Radio Service) antenna, an ETC (Electronic toll Collection) antenna, or the like.

The GPS (Global Positioning System) is a satellite positioning system using artificial satellites which are called GPS satellites. The GPS is a system which receives a radio wave (a GPS signal) from four GPS satellites among twenty-four GPS satellites orbiting the Earth, measures, on the basis of the received waves, a position relationship and a time error between a mobile object and the four GPS satellites, and accurately calculates, on the basis of a principal of triangulation techniques, a position and/or a height of the mobile object on a map.

In recent years, the GPS is used in a car navigation system for detecting a position of a running automobile or the like and becomes widespread. In the car navigation system, a car navigation apparatus comprises a GPS antenna for receiving the GPS signal, a processing unit for processing the GPS signal received by the GPS antenna to detect a current position of the vehicle, a display unit for displaying, on the map, the position detected by the processing unit, and so on. A plane antenna such as a patch antenna is used as the GPS antenna.

On the other hand, the SDARS (Satellite Digital Audio Radio Service) is a radio service according to a digital radio broadcasting using artificial satellites (which will called “SDARS satellites” hereinafter) in the United States of America. That is, in recent years, a digital radio receiver, which receives the satellite wave from the SDARS satellites or the terrestrial wave so as to listen to the digital radio broadcasting, has been developed and is put to practical use in the United States of America. Specifically, two broadcasting stations called XM and Sirius provide radio programs on 250 or more channels in total. The digital radio receiver is generally mounted on a mobile object such as an automobile and is adapted to receive a radio wave having a frequency of about 2.3 gigahertz (GHz) as a received wave to listen to the digital radio broadcasting. In other words, the digital radio receiver is a radio receiver capable of listening to mobile broadcasting. Inasmuch as the received wave has the frequency of about 2.3 GHz, a reception wavelength (resonance frequency) λ thereof is equal to about 128.3 mm. It is noted here that the terrestrial wave is a radio wave obtained by receiving the satellite wave at a ground station, slightly shifting the frequency of the satellite wave, and retransmitting the linear polarized wave. Thus, the terrestrial wave is the linear polarized wave exhibiting linear polarization while the satellite wave is a circular polarized wave exhibiting circular polarization. A plane antenna such as a patch antenna is used as the SDARS antenna.

An XM satellite radio antenna apparatus normally serves to receive circular polarized radio waves from two stationary satellites and, in an insensitive zone of the circular polarized waves, receives a radio wave by using a terrestrial linear polarization portion of the radio antenna apparatus. On the other hand, a Sirius satellite radio antenna apparatus normally serves to receive circular polarized radio waves from three orbiting satellites (synchronous type) and, in the insensitive zone, receives a radio wave by a terrestrial linear polarization portion of the radio antenna apparatus.

As described above, the radio wave having the frequency of about 2.3 GHz is used in the digital radio broadcasting. Therefore, an antenna for receiving the radio wave must be located outside as known in the art. If the digital radio receiver is mounted in the mobile object such as the automobile, the antenna unit is must be attached to a roof of the mobile object (car body).

A hybrid antenna unit is disclosed in Japanese Unexamined Patent Application Publication Tokkai No. 2007-13273, namely, JP 2007-13273 A1 (which corresponds to U.S. Patent Application Publication No. US 2006/0290580 A1), which will be called a first patent document. The hybrid antenna unit disclosed in the first patent document comprises a main circuit board having first and second surfaces opposite to each other, a first antenna unit, mounted on the first surface, for receiving a first radio wave from a first kind of artificial satellites, and a second antenna unit, mounted on the first surface, for receiving a second radio wave from a second kind of artificial satellites. The first antenna unit comprises the GPS antenna for receiving the first radio wave from the GPS satellites as the first kind of artificial satellites. The second antenna unit comprises the SDARS antenna for receiving the second radio wave from the SDARS satellites as the second kind of artificial satellites. At any rate, the hybrid antenna unit disclosed in the first patent document comprises a first plane antenna used as the GPS antenna and a second plane antenna used as the SDARS antenna which are put side by side with each other.

The ETC (Electronic tool Collection) is a system which is developed as a means for relieving the congestion of traffic at a tollbooth for paying passage tolls for a toll road such as an expressway. That is, the ETC is the system for automatically paying, in an expressway tollbooth, the passage tolls using wireless communication. In the ETC, interactive communications are carried out between a road antenna provided to a gate mounted in the tollbooth and a passage vehicle equipping with a vehicle-mounted communication equipment comprising the ETC antenna to get vehicle information of the passage vehicle or the like and to carry out payment operations of the passage tolls for the expressway without making the passage vehicle stop.

A hybrid antenna apparatus where the GPS antenna and the ETC antenna are disposed in parallel with each other is known in Japanese Unexamined Patent Application Publication Tokkai No. 2002-111377, namely, JP 2002-111377A1 which will be called a second patent document. The antenna apparatus disclosed in the second patent document comprises a GPS antenna element for receiving a GPS signal, an ETC antenna element for receiving an ETC signal, a circuit board having a processing circuit for processing the GPS signal and the ETC signal, and an output cable for producing a processed GPS signal and a processed ETC signal. The second patent document describes that an antenna element disposed in parallel with the GPS antenna element is not restricted to the ETC antenna element and may be an antenna element for receiving a wireless communication signal or the like such as an antenna for digital radio communications.

In addition, an antenna apparatus including a plurality of antennas for receiving radio waves different from one another is proposed in Japanese Unexamined Patent Application Publication Tokkai No. 2002-50925, namely, JP 2002-50925 A1 (which corresponds to U.S. Pat. No. 6,538,611), which will be called a third patent document. The antenna apparatus disclosed in the third patent document comprises a plurality of antennas for receiving, as reception signals, radio waves different from one another in frequency, a single case to which the antennas are mounted, and a single cable for transmitting a receiver body a combined reception signal obtained by combining the reception signals received by the antennas.

In the manner which is disclosed in the above-mentioned first through third patent documents, a related hybrid antenna unit for receiving two kinds of radio waves comprises two antenna elements (units) which are put side by side with each other. Therefore, the related hybrid antenna unit is disadvantageous in that it is upsized.

### SUMMARY OF THE INVENTION

It is therefore an exemplary object of the present invention to provide a miniature antenna element which is capable of receiving two kinds of radio waves and to an antenna unit comprising the same.

It is another exemplary object of the present invention to provide a miniature antenna element which is capable of receiving, as the two kinds of radio waves, a GPS signal and a SDARS signal and to an antenna unit comprising the same.

Other objects of this invention will become clear as the description proceeds.

According to a first aspect of this invention, an antenna element is for receiving first and second radio waves which are different from each other. The antenna element comprises a dielectric board having a side surface, a top surface and a bottom surface which are opposed to each other. The dielectric board has a board through hole which penetrates from the top surface to the bottom surface at a feeding point. A ring-shaped first antenna radiation electrode is made of a conductive film. The first antenna radiation electrode is formed on the top surface of the dielectric board at an outer region thereof. A second antenna radiation electrode is made of a conductive film. The second antenna radiation electrode is formed on top surface of the dielectric board at a central portion thereof so as to be enclosed by the first antenna radiation electrode and to be apart from the first antenna radiation electrode. A ground electrode is made of a conductive film. The ground electrode is formed on the bottom surface of the dielectric board. The ground electrode has a ground through hole which is substantially concentric with the board through hole and which has a diameter larger than that of the board through hole. A feeding pattern is formed on the side surface of the dielectric board. The feeding pattern feeds to the first antenna radiation electrode by electromagnetic coupling. A feeding pin has a first end connected to the second antenna radiation electrode at the feeding point. The feeding pin has a second end which is guided to the bottom surface side of the dielectric board via the board through hole and the ground through hole. A combination of the first antenna radiation electrode, the ground electrode, and the feeding pattern serves as a first antenna portion for receiving the first radio wave while a combination of the second antenna radiation electrode, the ground electrode, and the feeding pin serves as a second antenna portion for receiving the second radio wave.

According to a second aspect of this invention, an antenna unit comprises the above-mentioned antenna element, and a circuit board on which the antenna element is mounted. The circuit board comprises a first processing circuit for processing the first radio wave to produce a first processed signal, a second processing circuit for processing the second radio wave to produce a second processed signal, and a combining circuit for combining the first processed signal with the second processed signal to produce a combined signal. An output cable transmits the combined signal.

### BRIEF DESCRIPTION OF THE DRAWING

FIG. 1 is a perspective view of an antenna element (a patch antenna) according to an exemplary embodiment of this invention;

FIG. 2 is a bottom view of the antenna element illustrated in FIG. 1;

FIG. 3 is a front view of the antenna element illustrated in FIG. 1;

FIG. 4 is a view showing a return loss characteristic of a first antenna portion (a GPS antenna portion) of the antenna element illustrated in FIG. 1;

FIG. 5 is a view showing a return loss characteristic of a second antenna portion (a SDARS antenna portion) of the antenna element illustrated in FIG. 1;

FIG. 6 is a front view of an antenna unit including the antenna element illustrated in FIG. 1;

FIG. 7 is a block diagram showing a first exemplary embodiment of first and second processing circuits and a combining circuit which are contained on a circuit board of the antenna unit illustrated in FIG. 6;

FIG. 8 is a block diagram showing a second exemplary embodiment of first and second processing circuits and a combining circuit which are contained on a circuit board of the antenna unit illustrated in FIG. 6;

FIG. 9 is a block diagram showing a third exemplary embodiment of first and second processing circuits and a combining circuit which are contained on a circuit board of the antenna unit illustrated in FIG. 6;

FIG. 10 is a perspective view, partly in cross section, showing a hybrid antenna unit which comprises the antenna unit illustrated in FIG. 6 and a bar antenna; and

FIG. 11 is a perspective view showing a portable navigation unit where an antenna cabinet accommodating the antenna unit illustrated in FIG. 6 is mounted on an upper portion thereof.

### DESCRIPTION OF THE EXEMPLARY EMBODIMENTS

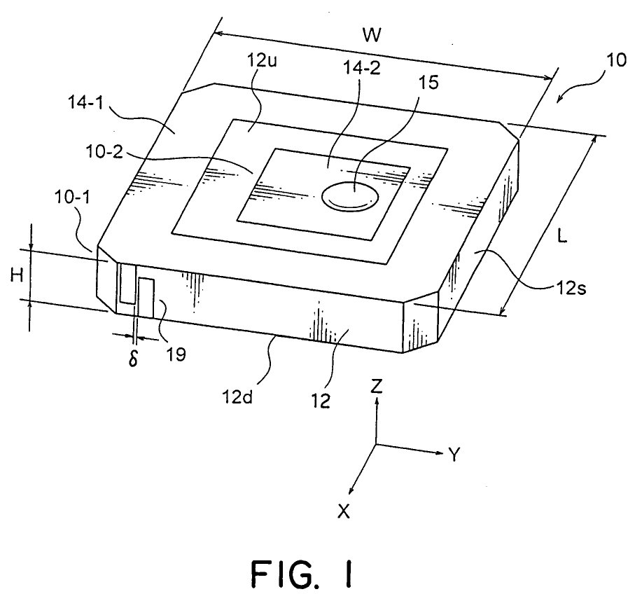

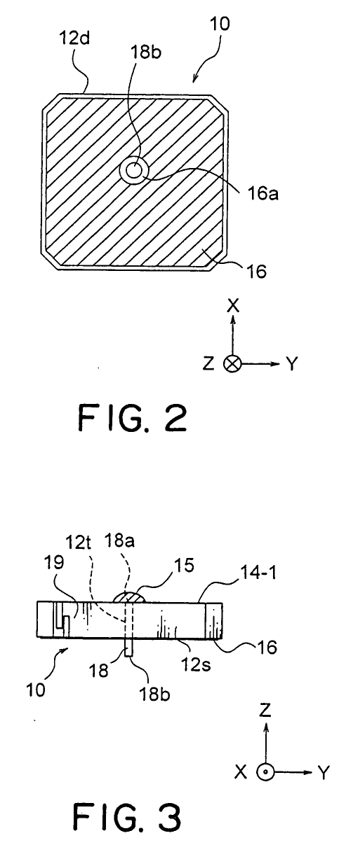

Referring to FIGS. 1 through 3, the description will proceed to an antenna element (a patch antenna) 10 according to an exemplary embodiment of the present invention. FIG. 1 is a perspective view showing the antenna element (the patch antenna) 10. FIG. 2 is a bottom view of the antenna element (the patch antenna) 10 illustrated in FIG. 1. FIG. 3 is a front view of the antenna element (the patch antenna) 10 illustrated in FIG. 1.

Herein, in the manner shown In FIGS. 1 to 3, an orthogonal coordinate system (X, Y, Z) is used. In a state illustrated in FIGS. 1 to 3, in the orthogonal coordinate system (X, Y, Z), an X-axis direction is a fore-and-aft direction (a depth direction), a Y-axis direction is a left-and-right direction (a width direction), and a Z-axis direction is an up-and-down direction (a height direction, a thickness direction).

The illustrated antenna element (the patch antenna) 10 is an antenna element for receiving first and second radio waves which are different from each other. The antenna element 10 comprises a dielectric board 12 having configuration of a substantially rectangular parallelepiped, first and second antenna radiation electrodes (radiation elements) 14-1 and 14-2, a ground electrode (a ground conductor) 16, a rod-shaped feeding pin 18, and a feeding pattern 19.

The illustrated dielectric board 12 is made of a ceramic material having a high permittivity (e.g. a relative permittivity εᵣ of 20) such as barium titanate. The dielectric board 12 has a side surface 12s, a top surface (an upper surface) 12u and a bottom surface (a lower surface) 12d which are opposed to each other in the up-and-down direction Z. In the example being illustrated, the side surface 12s of the dielectric board 12 has corners which are chamfered. The dielectric board 12 has a board through hole 12t (see FIG. 3) for penetrating from the top surface 12u to the bottom surface 12d at a position where a feeding point 15 is mounted.

The illustrated dielectric board 12 has a length L in the fore-and-aft direction X, a width in the right-and-left direction Y, and a height H in the up-and-down direction which are equal to 25 mm, 25 mm, and 4 mm, respectively.

The first antenna radiation element 14-1 is made of a conductive film. The first antenna radiation element 14-1 is formed on the top surface 12u of the dielectric board 12 at an outer region thereof. The first antenna radiation element 14-1 is shaped like a ring. The first antenna radiation element 14-1 is formed, for example, by silver pattern printing.

The second antenna radiation element 14-2 is also made of a conductive film. The second antenna radiation element 14-2 is formed on the top surface 12u of the dielectric board 12 at a central portion thereof. The illustrated second antenna radiation element 14-2 is a rectangle in shape that has a length and a width which are equal to 12.3 mm and 12.5 mm, respectively. The second antenna radiation element 14-2 is enclosed by the first antenna radiation element 14-1 and is apart from the first antenna radiation element 14-1. The second antenna radiation element 14-2 is formed, for example, by silver pattern printing.

As shown in FIG. 2, the ground electrode 16 is made of a conductive film. The ground electrode 16 is formed on the bottom surface 12d of the dielectric board 12. The ground electrode 16 has a ground through hole 16a which is substantially concentric with the board through hole 12-1 and which has a diameter larger than that of the board through hole 12-1.

The above-mentioned feeding point 15 is disposed at a position which is displaced from a center of the second antenna radiation electrode 14-2 in the X-axis direction and in the Y-axis direction. To the feeding point 15, a first end 18a of the feeding pin 18 is connected. The feeding pin 18 has a second end 18b which is guided toward the undersurface via the board through hole 12t and the ground through hole 16a so as to be apart from the ground electrode 16. Herein, solder is used as the feeding point 15. Therefore, the feeding point 15 has a convex shape which is bowed outward from a main surface of the second antenna radiation element 14-2.

The feeding pattern 19 is formed on the side surface 12s of the dielectric board 12. The feeding pattern 19 is for feeding to the first antenna radiation element 14-1 by electromagnetic coupling. As shown in FIG. 1, the feeding pattern 19 has a gap δ. By changing a size of the gap δ, it is possible to carrying out adjustment of an impedance.

In the antenna element 10 has such a structure, a combination of the first antenna radiation element 14-1, the ground electrode 16, and the feeding pattern 19 serves as a first antenna portion 10-1 for receiving the first radio wave while a combination of second antenna radiation element 14-2, the ground electrode 16, and the feeding pin 18 serves as a second antenna portion 10-2 for receiving the second radio wave. In the example being illustrated, the first antenna portion 10-1 comprises a GPS antenna portion for receiving, as the first radio wave, a GPS signal from GPS satellites while the second antenna portion 10-2 comprises a SDARS antenna portion for receiving, as the second radio wave, a SDARS signal from SDARS satellites.

Inasmuch as such an antenna element (patch antenna) 10 comprises the first antenna portion (the GPS antenna portion) 10-1 and the second antenna portion (the SDARS antenna portion) 10-2 which are integrally formed in the single dielectric board 12, it is possible to come down in size in comparison with that where two antenna elements are put side by side with each other in the manner which is described in the above-mentioned first and second patent documents.

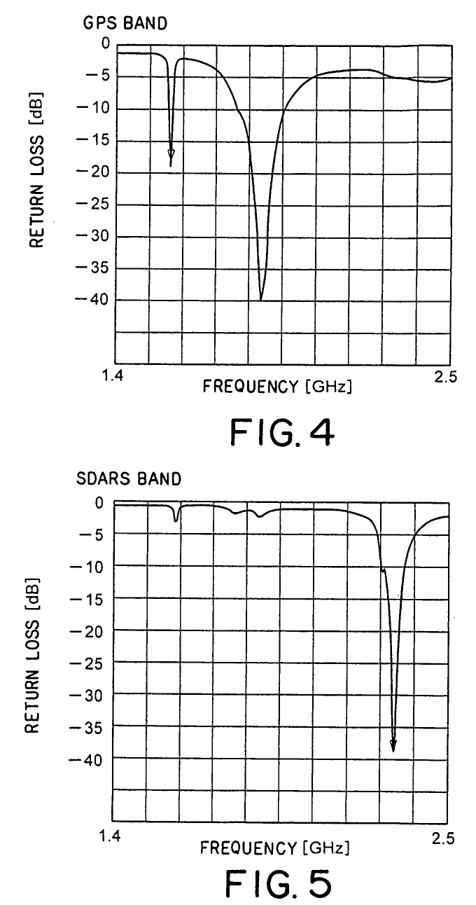

FIG. 4 shows a return loss characteristic of the first antenna portion (the GPS antenna portion) 10-1 while FIG. 5 shows a return loss characteristic of the second antenna portion (the SDARS antenna portion) 10-2. In each of FIGS. 4 and 5, the abscissa represents a frequency [GHz] and the ordinate represents a return loss [dB].

In the manner which is apparent from FIG. 4, it is seen that the first antenna portion (the GPS antenna portion) 10-1 has a low return loss at a GPS band having a frequency of 1.57542 GHz. In addition, in the manner which is apparent from FIG. 5, it is seen that the second antenna portion (the SDARS antenna portion) 10-2 has a low return loss at a SDARS band having a frequency of 2.32625 GHz.

Although the feeding pattern 19 is formed on the side surface 12s of the dielectric board 12 at one place in the antenna element 10 illustrated in FIGS. 1 to 3, a plurality of feeding patterns may be formed on the side surface 12s of the dielectric board 12 at a plurality of places. In this event, a feeding phase shifter (not shown) may be used. More specifically, the radio wave received by the first antenna radiation element 14-1 is divided through feeding patterns 19 into a plurality of partial received radio waves which are phase shifted and combined by the phase shifter so as to match phases of the partial receives radio waves to obtain a combined radio wave.

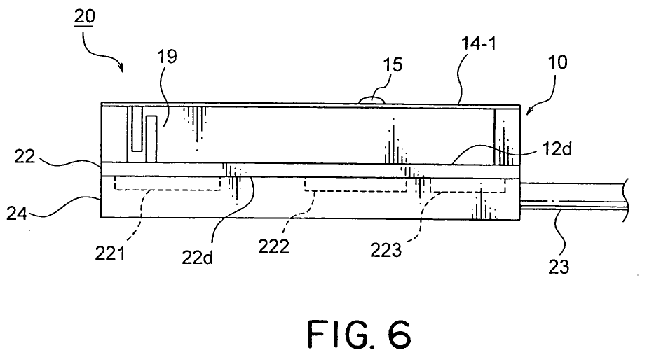

FIG. 6 is a front view of an antenna unit 20 using the antenna element 10 illustrated in FIGS. 1 to 3.

The antenna unit 20 comprises a circuit board 22 mounted on the bottom surface 12d of the antenna element 10 (the dielectric board 12) and an output cable 23. The circuit board 22 comprises, on a bottom surface 22d thereof, a first processing circuit 221, a second processing circuit 222, and a combining circuit 223. The first processing circuit 221 processes the first radio wave to produce a first processed signal. The second processing circuit 222 processed the second radio wave to produce a second processed signal. The combining circuit 223 combines the first processed signal with the second processed signal to produce a combined signal. The output cable 23 transmits the combined signal. That is, the combined signal is supplied through the output cable 23 to a predetermined processing apparatus (set) (not shown). The first processing circuit 221, the second processing circuit 222, and the combining circuit 223 are covered by a shielding cover 24.

In addition, in the set side, the combined signal received through the output cable 23 is distributed by a splitter (not shown) into the first processed signal and the second processed signal.

In the manner which is described above, in the illustrated antenna element (patch antenna) 10, the first antenna portion 10-1 comprises the GPS antenna portion for receiving, as the first radio wave, the GPS signal from the GPS satellites while the second antenna portion 10-2 comprises the SDARS antenna portion for receiving, as the second radio wave, the SDARS signal from the SDARS satellites. Under the circumstances, the first processing circuit 221 includes a GPS low noise amplifying portion for amplifying a weak GPS signal received by the GPS antenna portion 10-1 to produce an amplified GPS signal as the first processed signal. The second processing circuit 222 includes a SDARS low noise amplifying portion for amplifying a weak SDARS signal received by the SDARS antenna portion 10-2 to produce an amplified SDARS signal as the second processed signal.

Inasmuch as the antenna unit 20 according to the embodiment of this invention mixes and processes the first radio wave and the second radio wave in the manner which is described above, it results in space savings and it is possible to reduce costs.

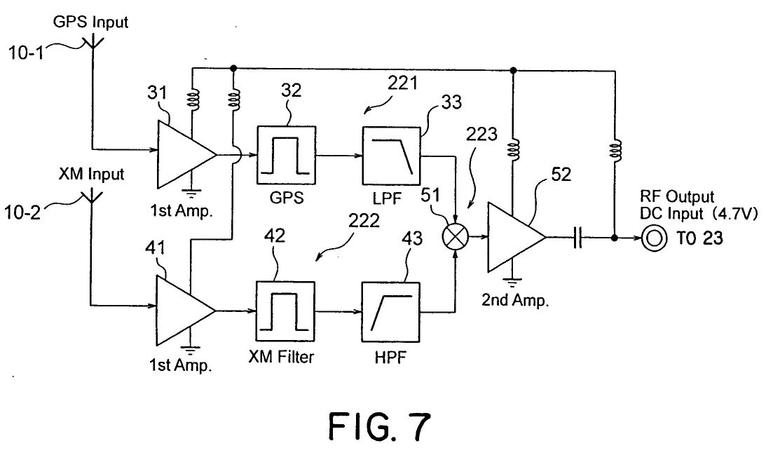

Referring now to FIGS. 7 through 9, the description will proceed to concrete examples of the first processing circuit, the second processing circuit, and the combining circuit which are contained on the circuit board 22. Herein, the description will be made as regards a case where the SDARS is the XM. Accordingly, the SDARS antenna portion 10-2 comprises an XM antenna portion and the SDARS signal comprises an XM signal.

Referring first to FIG. 7, the description will proceed to a first exemplary embodiment of the first and the second processing circuits 221 and 222 and the combining circuit 223 which are contained on the circuit board 22.

The first processing circuit 221 comprises a first GPS amplifier 31, a GPS band-pass filter 32, and a low-pass filter (LPF) 33. The first GPS amplifier 31 amplifies the GPS signal received by the GPS antenna portion 10-1 to produce a first GPS amplified signal. The GPS band-pass filter 32 passes through a signal of a GPS band (a frequency band of 1.5 GHz) among the first GPS amplified signal to produce a GPS band-pass filtered signal as the first processed signal. A combination of the first GPS amplifier 31 and the GPS band-pass filter 32 serves as the above-mentioned GPS low noise amplifying portion. The low-pass filter 33 passes through the GPS band-pass filtered signal (the first processed signal) as it is and inhibits the combined signal from the combining circuit 223 which will later be described from flowing back to the GPS low noise amplifying portion in question. That is, the low-pass filter 33 acts as a first backflow preventing arrangement for preventing the combined signal from flowing from the combining circuit 223 back to the GPS low noise amplifying portion. At any rate, the GPS band-pass filtered signal is supplied to the combining circuit 223 through the low-pass filter 33.

The second processing circuit 222 comprises a first XM amplifier 41, an XM band-pass filter 42, and a high-pass filter (HPF) 43. The first XM amplifier 41 amplifies the XM signal received by the XM antenna portion 10-2 to produce a first XM amplified signal. The XM band-pass filter 42 passes through a signal of an XM band (a frequency band of 2.3 GHz) among the first XM amplified signal to produce an XM band-pass filtered signal as the second processed signal. A combination of the first XM amplifier 41 and the XM band-pass filter 42 serves as the above-mentioned SDARS low noise amplifying portion (an XM low noise amplifying portion). The high-pass filter 43 passes through the XM band-pass filtered signal (the second processed signal) at it is and inhibits the combined signal the combining circuit 223 which will later be described from flowing back to the SDARS low noise amplifying portion (the XM low noise amplifying portion) in question. That is, the high-pass filter 43 acts as a second backflow preventing arrangement for preventing the combined signal from flowing from the combining circuit 223 back to the SDARS low noise amplifying portion (the XM low noise amplifying portion). At any rate, the XM band-pass filtered signal is supplied to the combining circuit 223 through the high-pass filter 43.

The combining circuit 223 comprises a combining balun 51 and a second combining amplifier 52. The combining balun 51 combines the GPS band-pass filtered signal (the first processed signal) with the XM band-pass filtered signal (the second processed signal) to produce an original combined signal. The second combining amplifier 52 amplifies the original combined signal to produce an amplified signal as the above-mentioned combined signal. Although the combining balun 51 is used for combining the GPS band-pass filtered signal (the first processed signal) with the XM band-pass filtered signal (the second processed signal), the combining balun 51 may not be used and the above-mentioned combining may be made by using only a wiring pattern for coupling two signal lines into a single signal line.

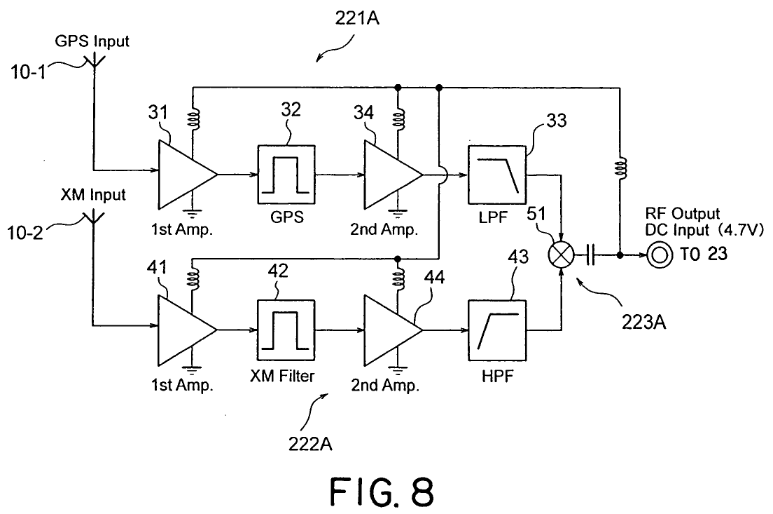

Referring now to FIG. 8, the description will proceed to a second exemplary embodiment of the first and the second processing circuits depicted at 221A and 222A and the combining circuit depicted at 223A which are contained on the circuit board 22.

The first processing circuit 221A is similar in structure to the first processing circuit 221 except that a second GPS amplifier 34 is inserted between the GPS band-pass filter 32 and the low-pass filter (LPF) 33.

The second GPS amplifier 34 amplifies the GPS band-pass filtered signal from the GPS band-pass filter to produce a second GPS amplified signal as the first processed signal. A combination of the first GPS amplifier 31, the GPS band-pass filter 32, and the second GPS amplifier 34 serves as the above-mentioned GPS low noise amplifying portion. The low-pass filter 33 passes through the second GPS amplified signal (the first processed signal) as it is and inhibits the combined signal from the combining circuit 223A which will later be described from flowing back to the GPS low noise amplifying portion in question. At any rate, the second GPS amplified signal is supplied to the combining circuit 223A through the low-pass filter 33 as the first processed signal.

The second processing circuit 222A is similar in structure to the second processing circuit 222 illustrated in FIG. 7 except that a second XM amplifier 44 is inserted between the XM band-pass filter 42 and the high-pass filter (HPF) 43.

The second XM amplifier 44 amplifies the XM band-pass filtered signal from the XM band-pass filter 42 to produce a second XM amplified signal as the second processed signal. A combination of the first XM amplifier 41, the XM band-pass filter 42, and the second XM amplifier 44 serves as the above-mentioned SDARS low noise amplifying portion (the XM low noise amplifying portion). The high-pass filter 43 passes through the second XM amplified signal (the second processed signal) as it is and inhibits the combined signal from the combining circuit 223A which will later be described from flowing back to the SDARS low noise amplifying portion (the XM low noise amplifying portion) in question. At any rate, the second XM amplified signal is supplied to the combining circuit 223A through the high-pass filter 43 as the second processed signal.

The combining circuit 223A comprises only the combing balun 51. The combining balun 51 combines the second GPS amplified signal (the first processed signal) with the second XM amplified signal (the second processed signal) to produce the above-mentioned combined signal. Although the combining balun 51 is used for combining the second GPS amplified signal (the first processed signal) with the second XM amplified signal (the second processed signal), the combining balun 51 may not be used and the above-mentioned combining may be made by using only a wiring pattern for coupling two signal lines into a single signal line.

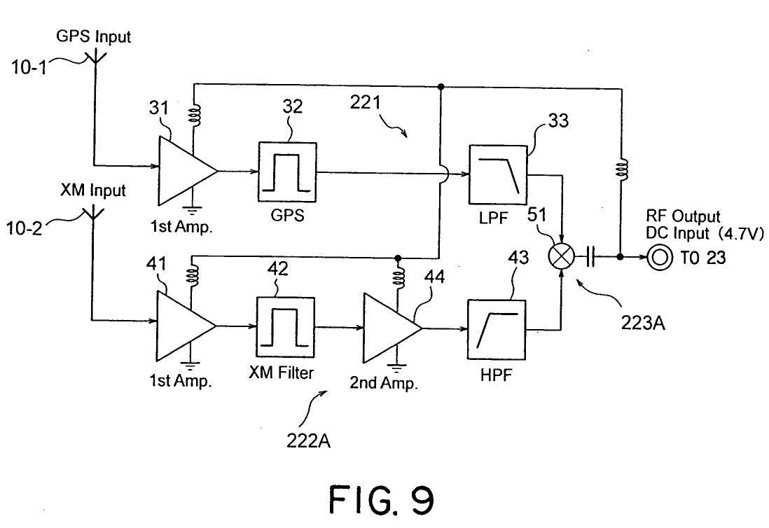

Referring finally to FIG. 9, the description will proceed to a third exemplary embodiment of the first and the second processing circuits 221 and 222A and the combining circuit 223A which are contained on the circuit board 22. That is, the this exemplary embodiment is similar in structure to the second exemplary embodiment illustrated in FIG. 8 except that the first processing circuit is similar to that illustrated in FIG. 7. In other words, the third exemplary embodiment is adequate to a use (a case) where there is no necessity to amplify the received GPS signal much.

The combining balun 51 combines the GPS band-pass filtered signal (the first processed signal) with the second XM amplified signal (the second processed signal) to produce the above-mentioned combined signal. Although the combining balun 51 is used for combining the second GPS band-pass filtered signal (the first processed signal) with the second XM amplified signal (the second processed signal), the combining balun 51 may not be used and the above-mentioned combining may be made by using only a wiring pattern for coupling two signal lines into a single signal line.

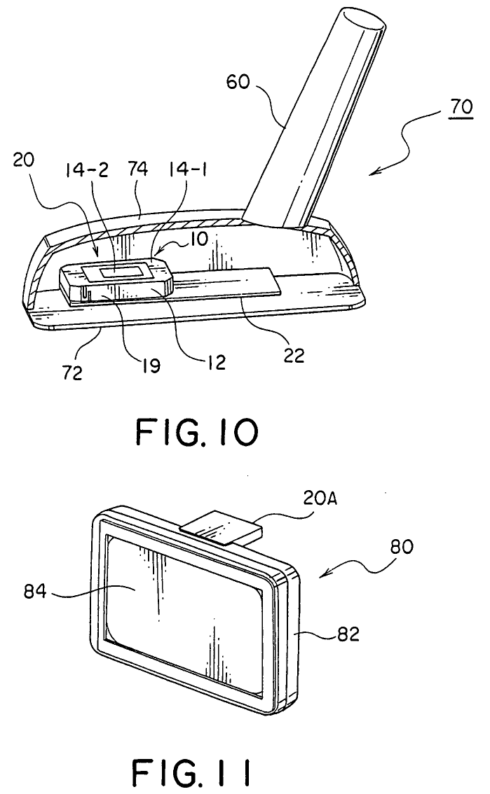

Referring to FIG. 10, the description will proceed to a first use of the antenna unit 20 illustrated in FIG. 6. FIG. 10 is a perspective view, partly in cross section, showing a hybrid antenna unit 70 which comprises the antenna unit 20 and a bar antenna 60. The bar antenna 60 receives both of a radio wave of AM/FM radio bands and a radio wave for a mobile telephone or a car phone. The antenna unit 20 is covered by an antenna base 72 and a top case 74. The bar antenna 60 stands on the top case 74 in a slanting position.

In the conventional art as disclosed in the third patent document, it is necessary to place the GPS antenna element and the SDARS antenna element side by side with each other on the circuit board 22 and the conventional hybrid antenna unit has a large size. In comparison with this, inasmuch as the hybrid antenna unit 70 according to the first use comprises the antenna unit 20 according to the exemplary embodiment of this invention, it is possible to receive the GPS signal and the SDARS signal by the one antenna unit 20 and it is possible to shrink the size of the hybrid antenna unit 70.

In addition, in the conventional hybrid antenna unit where the GPS antenna element and the SDARD antenna element are places side by side with each other, interference occurs in directivity if both are disposed nearer to each other and it results in degradation in a receiving characteristic. In comparison whit this, inasmuch as the hybrid antenna unit 70 according to the first use can receive both by the antenna unit 20, interference between both is minimized and it is possible to receive the radio waves favorably.

Referring to FIG. 11, the description will proceed to a second use of the antenna unit 20 illustrated in FIG. 6. FIG. 11 is a perspective view showing a portable navigation unit 80 where an antenna cabinet 20A accommodating the antenna unit 20 is mounted on an upper portion thereof.

The portable navigation unit 80 comprises a unit cabinet 82 and a display unit 84 disposed to the unit cabinet 82 at a front surface thereof. The antenna cabinet 20A is mounted on the upper portion of the unit cabinet 82.

In a conventional portable navigation unit, it is necessary to provide two locations on the unit cabinet 82 for two antenna units which comprise the GPS antenna unit and the SDARS antenna unit. As a result, the conventional portable navigation unit is disadvantageous in that it becomes large and it results in increasing in cost. In comparison with this, the portable navigation unit 80 according to the second use can make location mounting the antenna unit the antenna cabinet 20A alone by adopting the antenna unit 20 according to the exemplary embodiment of this invention. As a result, it is possible to downsize the portable navigation unit 80. Furthermore, inasmuch as it is unnecessary to prepare a location mounting the SDARS antenna unit (or the GPS antenna unit) separately in the portable navigation unit 80 according to the second use, it is possible to reduce a cost.

In the afore-mentioned antenna element according to the first aspect of this invention, the dielectric board may be made of a ceramic material. Each of the first and the second radiation electrodes may be formed by silver pattern printing. The first antenna portion may comprise a GPS (Global Positioning System) antenna portion for receiving, as the first radio wave, a GPS signal from GPS satellites. The second antenna portion may comprise a SDARS (Satellite Digital Audio Radio Service) antenna portion for receiving, as the second radio wave, a SDARS signal from SDARS satellites.

In the afore-mentioned antenna unit according to the second aspect of this invention, the first antenna portion may comprise a GPS (Global Positioning System) antenna portion for receiving, as the first radio wave, a GPS signal from GPS satellites and the second antenna portion may comprise a SDARS (Satellite Digital Audio Radio Service) antenna portion for receiving, as the second radio wave, a SDARS signals from SDARS satellites. In this event, the first processing circuit includes a GPS low noise amplifying portion for amplifying the GPS signal to produce an amplified GPS signal as the first processed signal, and the second processing circuit includes a SDARS low noise amplifying portion for amplifying the SDARS signal to produce an amplified SDARS signal as the second processed signal. The first processing circuit preferably may further comprise a first backflow preventing arrangement for preventing the combined signal from flowing from the combining circuit back to the GPS low noise amplifying portion, and the second processing circuit preferably may further comprise a second backflow preventing arrangement for preventing the combined signal from flowing from the combining circuit back to the SDARS low noise amplifying portion. The first backflow preventing arrangement may comprise, for example, a low-pass filter for passing the first processed signal to the combining circuit and for inhibiting the combined signal from flowing back to the GPS low noise amplifying portion, and the second backflow preventing arrangement may comprise, for example, a high-pass filter for passing the second processed signal to the combining circuit and for inhibiting the combined signal from flowing back to the SDARS low noise amplifying portion.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. For example, a material of the dielectric board is not restricted to the ceramic material and the dielectric board may be made of resin material. In addition, although the antenna element (the patch antenna) according to this invention is adequate for receiving the GPS signal and the SDARS signal, this invention is not restricted to this and may be applicable to an antenna element for receiving first and second radio waves which are different from each other.

What is claimed is:

1. An antenna element for receiving first and second radio waves which are different from each other, said antenna element comprising:
a dielectric board having a side surface, a top surface and a bottom surface which are opposed to each other, said dielectric board having a board through hole which penetrates from the top surface to the bottom surface at a feeding point;
a ring-shaped first antenna radiation electrode made of a conductive film, said first antenna radiation electrode being formed on the top surface of said dielectric board at an outer region thereof;
a second antenna radiation electrode made of a conductive film, said second antenna radiation electrode being formed on top surface of said dielectric board at a central portion thereof so as to be enclosed by said first antenna radiation electrode and to be apart from said first antenna radiation electrode;
a ground electrode made of a conductive film, said ground electrode being formed on the bottom surface of said dielectric board, said ground electrode having a ground through hole which is substantially concentric with the board through hole and which has a diameter larger than that of the board through hole;
a feeding pattern formed on the side surface of said dielectric board, said feeding pattern feeding to said first antenna radiation electrode by electromagnetic coupling; and
a feeding pin having a first end connected to said second antenna radiation electrode at the feeding point, said feeding pin having a second end which is guided to the bottom surface side of said dielectric board via the board through hole and the ground through hole,
wherein a combination of said first antenna radiation electrode, said ground electrode, and said feeding pattern serves as a first antenna portion for receiving the first radio wave, and a combination of said second antenna radiation electrode, said ground electrode, and said feeding pin serves as a second antenna portion for receiving the second radio wave.

2. The antenna element as claimed in claim 1, wherein said dielectric board is made of a ceramic material.

3. The antenna element as claimed in claim 1, wherein each of said first and said second radiation electrodes is formed by silver pattern printing.

4. The antenna element as claimed in claim 1, wherein said first antenna portion comprises a GPS (Global Positioning System) antenna portion for receiving, as the first radio wave, a GPS signal from GPS satellites and wherein said second antenna portion comprises a SDARS (Satellite Digital Audio Radio Service) antenna portion for receiving, as the second radio wave, a SDARS signal from SDARS satellites.

5. An antenna unit comprising:
an antenna element as claimed in claim 1;
a circuit board on which said antenna element is mounted, said circuit board comprising a first processing circuit for processing the first radio wave to produce a first processed signal, a second processing circuit for processing the second radio wave to produce a second processed signal, and a combining circuit for combining the first processed signal with the second processed signal to produce a combined signal; and
an output cable for transmitting the combined signal.

6. The antenna unit as claimed in claim 5, wherein said first antenna portion comprises a GPS (Global Positioning System) antenna portion for receiving, as the first radio wave, a GPS signal from GPS satellites and wherein said second antenna portion comprises a SDARS (Satellite Digital Audio Radio Service) antenna portion for receiving, as the second radio wave, a SDARS signals from SDARS satellites.

7. The antenna unit as claimed in claim 6, wherein
said first processing circuit includes a GPS low noise amplifying portion for amplifying the GPS signal to produce an amplified GPS signal as the first processed signal, and
said second processing circuit including a SDARS low noise amplifying portion for amplifying the SDARS signal to produce an amplified SDARS signal as the second processed signal.

8. The antenna unit as claimed in claim 7, wherein
said first processing circuit further comprises a first backflow preventing arrangement for preventing the combined signal from flowing from said combining circuit back to said GPS low noise amplifying portion, and
said second processing circuit further comprising a second backflow preventing arrangement for preventing the combined signal from flowing from said combining circuit back to said SDARS low noise amplifying portion.

9. The antenna unit as claimed in claim 8, wherein
said first backflow preventing arrangement comprises a low-pass filter for passing the first processed signal to said combining circuit and for inhibiting the combined signal from flowing back to said GPS low noise amplifying portion, and
said second backflow preventing arrangement comprising a high-pass filter for passing the second processed signal to said combining circuit and for inhibiting the combined signal from flowing back to said SDARS low noise amplifying portion.
